(19) United States
(12) Patent Application Publication
(10) Pub. No.: US 2004/0179438 A1
(43) Pub. Date: Sep. 16, 2004

(54) Optical head apparatus and optical disk apparatus using this optical head apparatus

(75) Inventor: Hiroshi Shinozuka, Fuchu-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/786,616

(22) Filed: Feb. 26, 2004

(30) Foreign Application Priority Data
Feb. 28, 2003 (JP) 2003-054999

(51) Int. Cl. G11B 7/00

(52) U.S. Cl. 369/44.11

(57) ABSTRACT

An optical head apparatus according to the present invention has a flat coil in which a focusing coil and a tracking coil are integrally formed on both surfaces or one surface of a pair of insulative.

### CROSS-REFERENCE TO RELATED APPLICATIONS

This application is based upon and claims the benefit of priority from prior Japanese Patent Application No. 2003-054999, filed Feb. 28, 2003, the entire contents of which are incorporated herein by reference.

### BACKGROUND OF THE INVENTION

1. Field of the Invention

The present invention relates to an optical head and an optical disk apparatus which are used to record information or reproduce information in an optical disk as an information recording medium.

2. Description of the Related Art

In recent years, demands for an increase in double speed that information can be recorded at a high double speed such as 8 to 48-fold speeds, a reduction in size or the like are growing with respect to an information recording/reproducing apparatus (optical disk apparatus). Based on this, rigorous design conditions are imposed on an optical disk apparatus which records information in an optical disk or reproduces information from the optical disk.

In particular, a high-speed access, i.e., a high sensitivity is demanded in regard to an actuator. A sensitivity of the actuator (AC sensitivity) is obtained as follows.

AC sensitivity=F/m, F=Biln

F is a motive energy and m is a mass of an actuator movable portion. As a method of increasing the sensitivity, there are improving a magnetic flux density, allowing a maximum current, increasing the winding number in an effective range and others.

It is needless to say that the sensitivity is improved by reducing a mass of the actuator. However, in an MC type actuator in which a coil is moved, a main mass of the actuator is a coil mass, and the winding number of the coil is in inverse proportion to an improvement in the sensitivity. Therefore, a reduction in weights of coils is demanded.

It is to be noted that, there is known a coil obtained by attaching glass-containing substrates on which coils are printed as means for reducing weights of coils.

For example, Jpn. Pat. Appln. KOKAI Publication No. 3-283404 discloses an apparatus which uses sheet coils having terminal holes and laminates coils by utilizing terminals which match with the terminal holes.

Further, in order to improve the sensitivity, there is a method based on an air-core coil or a drum winding in case of increasing the effective winding number of the coil. In this case, when a line shape of the coil is narrowed, there is a problem that a coil wire in especially a bent portion is narrowed due to a tensile force of winding, a loss is generated in the coil wire and a withstand current value becomes small. It is to be noted that a coating for insulation is required, and it is needless to say that this is a cause of increasing a cubic content.

In the coils laminated by using the glass-containing epoxy substrates, a magnetic gap between windings is increased due to a thickness of each substrate. Further, the glass-containing epoxy substrate having coils printed on both surfaces thereof has less effects to increase the number of windings. Therefore, even if a multi-layer structure is adopted by using the glass-containing epoxy substrate having coils printed on both surfaces thereof, the effects to increase the number of windings of the coil are small, which may lead to a problem that an AC sensitivity becomes not more than a normal value.

Incidentally, when using a substrate thinner than the glass-containing epoxy substrate, the rigidity is insufficient, which results in another problem that an unnecessary mode of vibrations is generated.

### BRIEF SUMMARY OF THE INVENTION

This invention is to provide an optical head apparatus comprising:

an object lens which condenses light beams onto a recording surface of an information recording medium or the like which records information;

a lens holder which holds the object lens so as to be movable in an optical axis direction of the object lens and a direction parallel with the recording surface of the information recording medium;

a magnet which can provide a magnetic field having a predetermined polarity;

a flat coil which has a conductor composed of a metal foil or a metal pattern and formed into a coil shape on a sheet medium at a predetermined position of the lens holder and which generates a force in accordance with the magnetic field in order to move the lens holder at least in one of the optical axis direction and the direction parallel with the recording surface; and

a support member which supports the lens holder so as to be movable in predetermined directions.

Furthermore, this invention is to provide an optical head apparatus comprising:

an optical head which has: an object lens which condenses light beams onto a recording surface of an information recording medium or the like which records information; a lens holder which holds the object lens so as to be movable in an optical axis direction of the object lens and a direction parallel with the recording surface of the information recording medium; a magnet which can provide a magnetic field having a predetermined polarity; a flat coil which has a conductor composed of a metal foil or a metal pattern and formed into a coil shape on a sheet medium at a predetermined position of the lens holder and which generates a force in accordance with the magnetic field in order to move the lens holder at least in one of the optical axis direction and the direction parallel with the recording surface; and a support member which supports the lens holder so as to be movable in predetermined directions;

a photodetector which detects light beams reflected on the recording surface of the recording medium and converts them into an electric signal; and

an information processing circuit which reproduces information recorded in the recording medium from the electric signal outputted from the photodetector.

### BRIEF DESCRIPTION OF THE SEVERAL VIEWS OF THE DRAWING

FIG. 1 is a perspective view illustrating an example of an optical disk apparatus including an optical head apparatus according to an embodiment of the present invention;

FIG. 2 is a schematic view illustrating an operation principle of the optical head apparatus;

FIG. 3 is a schematic view illustrating an example of a signal processing system of the optical disk apparatus illustrated in conjunction with FIGS. 1 and 2;

FIG. 4 is a schematic view illustrating an example of an optical head apparatus incorporated in the optical disk apparatus depicted in FIGS. 1 to 3;

FIG. 5 is a schematic view illustrating an example of coils applied to the optical head apparatus described in conjunction with FIG. 4;

FIGS. 6A and 6B are schematic views illustrating another example of coils applied to the optical head apparatus described with reference to FIG. 4;

FIG. 7 is a schematic view illustrating another example of coils applied to the optical head apparatus explained in connection with FIG. 4;

FIG. 8 is a schematic view illustrating still another example of coils applied to the optical head apparatus explained in conjunction with FIG. 4;

FIG. 9 is a schematic view illustrating yet another example of coils applied to the optical head apparatus explained with reference to FIG. 4;

FIG. 10 is a schematic view illustrating a further example of coils applied to the optical head apparatus described in conjunction with FIG. 4;

FIGS. 11A to 11C are schematic views illustrating a still further example of coils applied to the optical head apparatus described in connection with FIG. 4;

FIGS. 12A to 12D are schematic views illustrating a yet further example of coils applied to the optical head apparatus described with reference to FIG. 4;

FIGS. 13A to 13D are schematic views illustrating examples of a sheet on which patterns depicted in FIGS. 12A to 12D are formed;

FIG. 14 is a schematic view illustrating contacts between coils arranged on the sheet depicted in FIG. 13A;

FIG. 15 is a schematic view illustrating contacts between coils arranged on the sheet depicted in FIG. 13B;

FIG. 16 is a schematic view illustrating contacts between coils arranged on the sheet depicted in FIG. 13C;

FIG. 17 is a schematic view illustrating a modification of a coil body shown in FIG. 16;

FIG. 18 is a schematic view illustrating another example of coils having one of the patterns depicted in FIGS. 12A to 12D;

FIG. 19 is a schematic view illustrating contacts between coils arranged on the sheet shown in FIG. 13D; and

FIG. 20 is a schematic view illustrating another example of coils applied to the optical head apparatus described in conjunction with FIG. 4.

### DETAILED DESCRIPTION OF THE INVENTION

Embodiments according to the present invention will now be described in detail hereinafter with reference to the accompanying drawings.

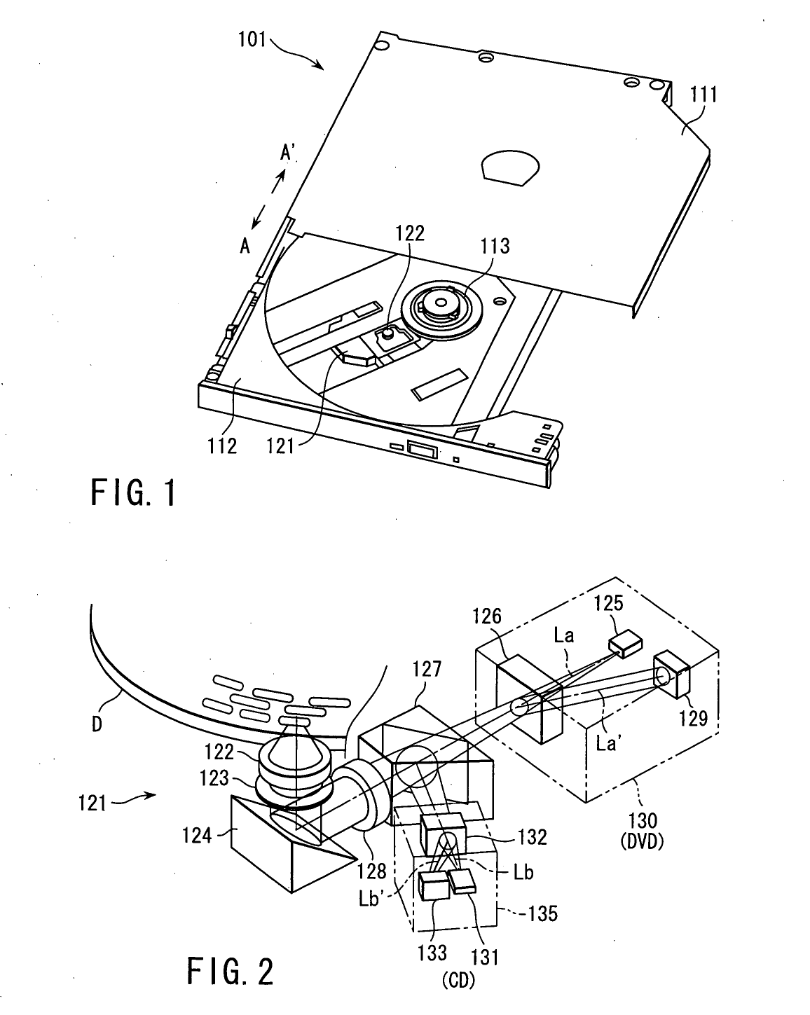

FIG. 1 shows an example of an optical disk apparatus including an optical head apparatus according to the present invention.

As shown in FIG. 1, an optical disk apparatus 101 has a housing 111 and a table unit 112 formed so as to be capable of performing an eject operation (movement in a direction indicated by an arrow A) or a loading operation (movement in a direction indicated by an arrow A′) with respect to the housing 111.

A turn table 113 which rotates an optical disk D with a predetermined number of revolutions is provided at a substantially central part of the table unit 112. It is to be noted that a part of the optical head apparatus 121 and an object lens 122 incorporated in the optical head apparatus 121 are exposedly seen when the optical disk is not loaded in a state that the table unit 112 is being ejected.

FIG. 2 is a schematic view illustrating an operation principle of the optical head apparatus in a state that elements of the optical head apparatus 121 of the optical disk apparatus 101 are removed.

As shown in FIG. 2, the optical head apparatus 121 has an object lens 122 which condenses light beams, i.e., laser beams onto a recording surface of the optical disk D and fetches laser beams reflected on the optical disk D (which will be referred to as reflected laser beams hereinafter).

The object lens 122 can arbitrarily move in a (focusing) direction orthogonal to the recording surface of the optical disk D and a (tracking) direction orthogonal to guide grooves or recording mark columns provided on the recording surface by utilizing a later-described change in position of the actuator.

A dichroic filter 123 which gives predetermined optical characteristics of the laser beams directed to the optical disk D through the object lens 122 and the reflected laser beams from the optical disk D is provided at a predetermined position on a side opposite to the optical disk D of the object lens 122.

A prism mirror 124 which reflects the laser beams guided in substantially parallel to the recording surface of the optical disk D toward the object lens 122 is provided at a predetermined position on a front side of the dichroic filter 123, i.e., a side opposite to the object lens 122.

A first laser element 125 which emits, e.g., laser beams having a wavelength of a red color is provided at a position which is substantially parallel with the recording surface of the optical disk D and can causes the laser beams to enter the prism mirror 124. It is to be noted that the first laser element 125 is utilized for reproduction of information from, e.g., a DVD-standardized optical disk and writing of information to a CD-based and DVD-standardized optical disks.

A light receiving characteristic setting element 126 to which a diffraction grating and a no-polarizing hologram are integrally formed, a dichroic prism 127 and a collimator lens 128 are provided between the first laser element 125 and the prism mirror 124 in the order from a side close to the laser element 125. It is to be noted that a first photodetector 129 which detects the reflected laser beams from the optical disk D is placed at a position satisfying predetermined conditions with respect to a position where the first laser element 126 is provided. The reflected laser beams to which a predetermined grating is given by the light receiving characteristic setting element 126 enter this first photo-detector 129.

It is to be noted that the first laser element 125, the light receiving characteristic setting element 126 and the first photodetector 129 are integrated as a DVD-oriented light emitting/light receiving unit (DVD-IOU) 130.

A second laser element 131 which emits laser beams having, e.g., a near infrared wavelength is provided at a position where the laser beams can be caused to enter toward the prism mirror 124 after reflected by the dichroic prism 127. It is to be noted that the second laser element 131 is utilized for reproduction of information from, e.g., a CD-based optical disk.

An FM hologram element 132 which gives characteristics suitable for recording information in the optical disk D to the laser beams emitted from the second laser element 131 is placed at a predetermined position between the second laser element 131 and the dichroic prism 127. It is to be noted that a function which gives predetermined light receiving characteristics to the reflected laser beams from the optical disk D is also given to the FM hologram element 132.

A second photodetector 133 which detects the reflected laser beams from the optical disk D is provided at a position satisfying predetermined conditions with respect to a position where the second laser element 131 is provided. The reflected laser beams to which a predetermined grating is given by the FM hologram element 132 enter this second photodetector 133. It is to be noted that the second laser element 131, the FM hologram element 132 and the second photodetector 133 are integrated as a CD-oriented light emitting/light receiving unit (CD-IOU) 135.

In the optical head apparatus 121 shown in FIG. 2, when information is recorded from the DVD-based optical disk, predetermined wavefront characteristics are given to laser beams La having a wavelength of, e.g., 660 nm outputted from the first laser element 125 by the light receiving characteristic setting element 126, and the laser beams La are caused to enter the dichroic prism 127.

The laser beams La which has entered the dichroic prism 127 are transmitted through the dichroic prism 127 and collimated by the collimator lens 128, and an advancing direction thereof is bent toward the object lens 122 by the prism mirror 124.

The laser beams La directed toward the object lens 122 by the prism mirror 124 are condensed onto the recording surface of the optical disk D through the dichroic filter 123.

Since a light intensity of the laser beams La condensed on the recording surface of the optical disk D is modulated in a signal processing system which will be described later in accordance with information to be recorded, a recording mark, i.e., a pit is formed on a recording film of the optical disk D if an energy per time is an energy which can change a phase of the recording film.

The reflected laser beams La′ reflected on the recording surface of the optical disk D are returned to the prism mirror 124 through the dichroic filter 123, and their advancing direction is again bent in substantially parallel with the recording surface of the optical disk D.

The reflected laser beams La′ bent by the prism mirror 124 are caused to enter the collimator lens 128 and led to the dichroic prism 127.

The reflected laser beams La′ returned to the dichroic mirror 127 are transmitted through the dichroic mirror 27 as they are, and directed toward the first photodetector 129 by the light receiving characteristic setting element 126.

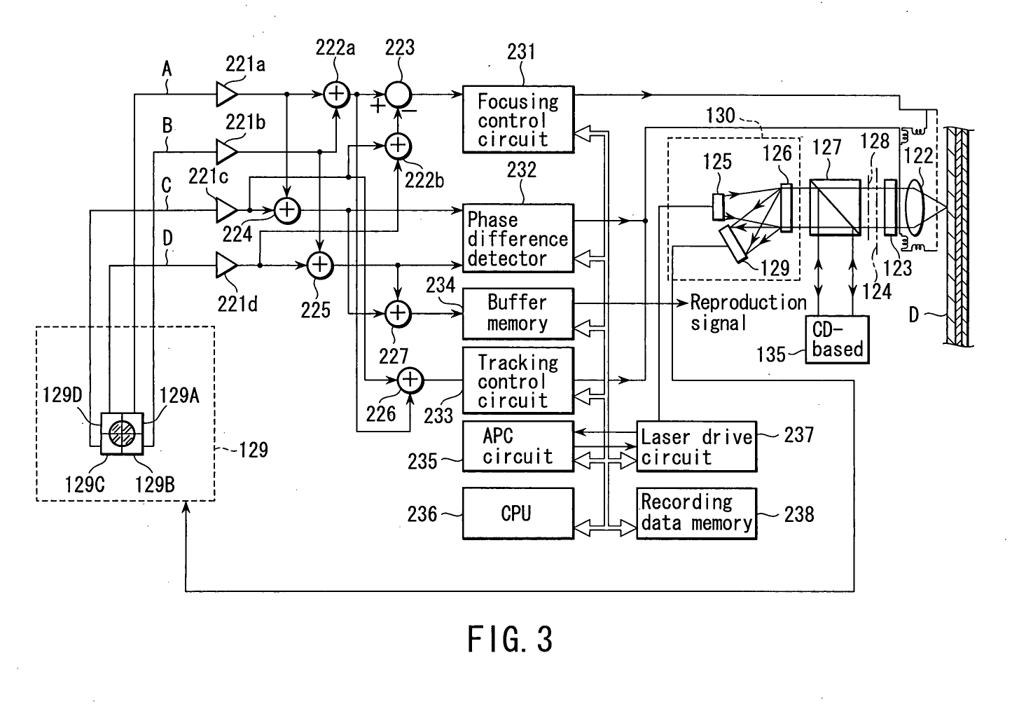

A part of the reflected laser beams La′ which have entered the first photodetector 129 is utilized for generation of a focusing error signal and a tracking error signal in a signal processing system shown in FIG. 3. That is, the object lens 122 is focus-locked at a position where a focus is achieved on the recording surface of the optical disk D, and tracking is controlled in such a manner that a center of tracks or pit columns of information pits previously formed on the recording surface matches with a center of the laser beams.

Furthermore, in cases where information is reproduced from the DVD-standardized optical disk, an intensity of the light beams La condensed on the recording surface of the optical disk D like the above-described storage of information is changed in accordance with the recording mark (pit column) recorded on the recording surface, and the light beams La are reflected from the optical disk D.

The reflected laser beams La′ reflected on the recording surface of the optical disk D are transmitted through the dichroic filter 123 and returned to the prism mirror 124, and their advancing direction is again bent in substantially parallel with the recording surface of the optical disk D.

The reflected laser beams La′ bent by the prism mirror 124 are caused to enter the collimator lens 128 and led to the dichroic prism 127.

The reflected laser beams La′ returned to the dichroic mirror 127 are transmitted through the dichroic mirror 127 as they are, and directed toward the first photodetector 129 by the light receiving characteristic setting element 126.

A part of the reflected laser beams La′ which have entered the first photodetector 129 is outputted to an external device or a temporary storage as a signal corresponding to a reproduction signal obtained by adding outputs from the first photodetector 129 in the signal processing system illustrated in FIG. 3.

On the other hand, in cases where information is reproduced in the CD-standardized optical disk, predetermined wavefront characteristics are given to laser beams Lb having a wavelength of, e.g., 780 nm outputted from the second laser element 131 by the FM hologram element 132, and the laser beams Lb are caused to enter the dichroic prism 127.

The laser beams Lb which have entered the dichroic prism 127 are reflected by the dichroic prism 127 and led to the collimator lens 128.

The laser beams Lb led to the collimator lens 128 are collimated by the collimator lens 128, and their advancing direction is bent toward the object lens 122 by the prism mirror 124.

The laser beams Lb directed toward the object lens 122 by the prism mirror 124 are transmitted through the dichroic filter 123 and condensed onto the recording surface of the optical disk D.

The reflected laser beams Lb′ reflected on the recording surface of the optical disk D are transmitted through the dichroic filter 123 and returned to the prism mirror 124, and their advancing direction is again bent in substantially parallel with the recording surface of the optical disk D. Then, the reflected laser beams Lb′ are returned to the dichroic prism 127 through the collimator lens 128.

The reflected laser beams Lb′ returned to the dichroic mirror 127 are reflected by the dichroic mirror 127, and directed toward the second photodetector 133 by the FM hologram element 132.

As a result, the reflected laser beams Lb′ whose intensity was changed in accordance with information recorded in the optical disk D and which was returned are caused to enter the second photodetector 133.

Thereafter, the reflected laser beams Lb′ are photoelectrically converted by the second photodetector 133, and their output is processed by the signal processing system which will be described later in connection with FIG. 3 and outputted to an external device or a temporary storage as a signal corresponding to information recorded in the optical disk D.

FIG. 3 is a schematic view illustrating an example of the signal processing system of the optical disk apparatus explained with reference to FIGS. 1 and 2. It is to be noted that reproduction of a signal from the CD-based optical disk (laser beams reflected on the dichroic prism) is omitted and reproduction of an output signal from the first photodetector, i.e., signal from the DVD-standardized optical disk, a focusing control and a tracking control will be mainly explained in FIG. 3.

The first photodetector 129 includes first to fourth domain photodiodes 129A, 129B, 129C and 129D. Outputs A, B, C and D from the respective photodiodes are amplified to a predetermined level by first to fourth amplifiers 221a, 221b, 221c and 221d, respectively.

In regard to the outputs A to D from the respective amplifiers 221a to 221d, A and B are added by a first adder 222a, and C and D are added by a second adder 222b.

As to outputs from the adders 222a and 222b, “(C+D) is added to (A+B) with signs being reversed” in an adder 223 (subtracted).

A result of addition (subtraction) by the adder 223 is supplied to a focusing control circuit 231 as a focusing error signal which is utilized to move the object lens 122 to a predetermined position in an optical axis direction running through the object lens in order to match a position of the object lens 122 with a focal distance which is a distance that the laser beams condensed through non-illustrated tracks previously formed on the recording surface of the optical disk D or non-illustrated pit columns as recording information and the object lens 122 are condensed.

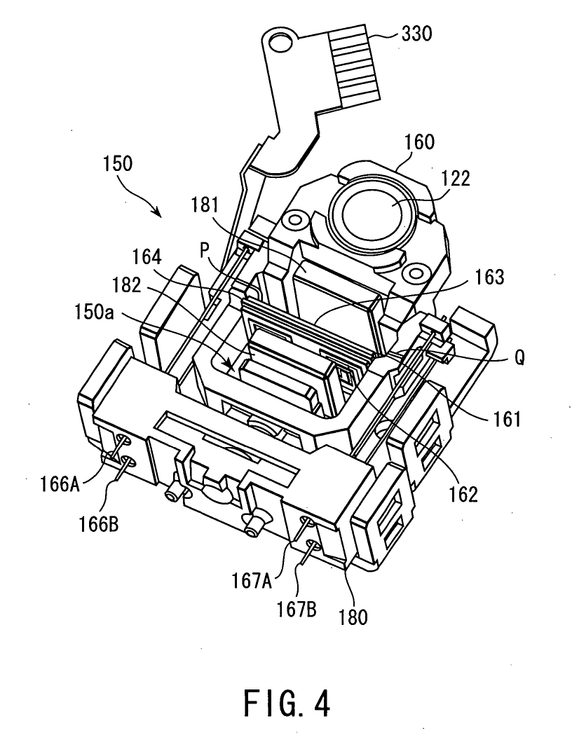

The object lens 122 is maintained on a predetermined track or pit column on the recording surface of the optical disk D in an on-focus state when a lens holder 310 (see FIG. 4) is moved in a predetermined direction by a thrust generated by a focusing control current supplied from a focusing control circuit 231 to a focusing coil 312 (see FIG. 4) based on a focusing error signal.

An adder 224 generates (A+C), and an adder 225 generates (B+C). Outputs from the both adders, i.e., (A+C) and (B+D) are inputted to a phase difference detector 232. The phase difference detector 232 is useful for acquisition of a correct tracking error signal when the object lens 122 is lens-shifted.

A sum of (A+B) and (C+D) is obtained by an adder 226, and it is supplied to a tracking control circuit 233 as a tracking error signal which is utilized to move the object lens 122 in a direction parallel to the recording surface of the optical disk D in order to match a position of the object lens 122 with a center of non-illustrated tracks previously formed on the recording surface of the optical disk D or non-illustrated pit columns as recording information.

The object lens 122 is maintained on a predetermined track or pit column on the recording surface of the optical disk D in an on-track state when the lens holder 310 is moved in a predetermined direction by a thrust which is supplied from the tracking control circuit 233 to a tracking coil 313 (see FIG. 4) based on the tracking error signal and generated by the tracking control.

It is to be noted that since the object lens 122 is lens-shifted in accordance with an output from the phase difference detector 232, a center of the laser beams condensed by the object lens 122 is moved by a distance corresponding to a predetermined track before and after a current track. (A+C) and (B+D) are further added by an adder 227, converted into an (A+B+C+D) signal, i.e., a reproduction signal and inputted to a buffer memory 234.

It is to be noted that an intensity of return light beams of the laser beams emitted from the first laser element 125 is inputted to an APC circuit 235. As a result, an intensity of recording laser beams emitted from the first laser element 125 based on recording data stored in a recording data memory 238 is stabilized.

In the optical disk apparatus 101 having such a signal detection system, when the optical disk D is set on the turn table 113 and a predetermined routine is activated by a control of a CPU 236, the recording surface of the optical disk D is irradiated with reproduction laser beams from the first laser element 125 by a control of a laser drive circuit 237.

Thereafter, the reproduction laser beams are continuously emitted from the first laser element 125, and a signal production operation is started although the detailed explanation is eliminated.

FIG. 4 is a schematic view illustrating an example of the optical head apparatus incorporated in the optical disk apparatus depicted in FIGS. 1 to 3.

As shown in FIG. 4, an optical pickup device 150 has a coil body 161, in which a focusing coil 162 and a tracking coil 163 are integrally formed by using a metal foil, a printed pattern or the like on both surfaces or one surface of an insulative sheet or film having a predetermined thickness, at a substantially central part of an actuator 160 having an opening portion 150a. It is to be noted that the coil body 161 may have a plurality of sheets on which coils are formed being laminated. Further, a plate-type magnetic body 164 may be sandwiched between arbitrary sheets of the coil body 161.

The optical pickup device 150 has an actuator base 180 having a first magnet 181 and a second magnet 182 which provide predetermined magnetic fields to the focusing coil 162 and the tracking coil 163 of the actuator 160.

The actuator 160 is supported so as to be movable in arbitrary directions through four wire members (elastic members) 166A, 166B, 167A and 167B provided at predetermined positions of the actuator base 180.

Currents based on a focusing error signal and a tracking error signal are supplied to the focusing coil 162, the tracking coil 163 and the actuator 160 through connection terminals P and Q as described in conjunction with FIG. 3. Magnetic fluxes having predetermined polarities are provided to the both coils 162 and 163 from the first and second magnets 181 and 182. Therefore, when the current based on the focusing error signal is supplied, the focusing coil 162 generates a thrust in a focusing direction. Furthermore, when the current based on the tracking error signal is supplied, the tracking coil 163 generates a thrust in the tracking direction.

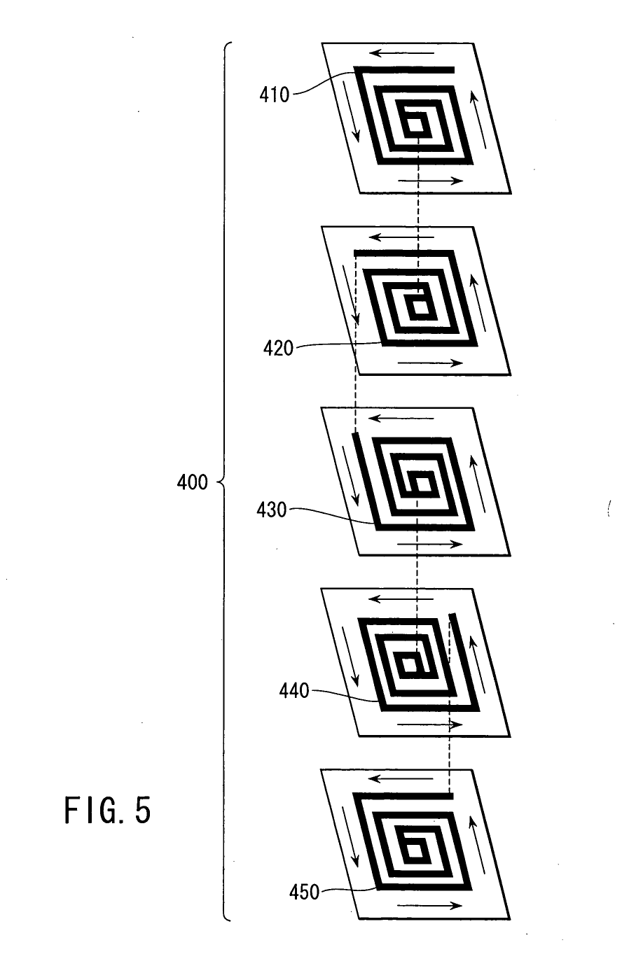

FIG. 5 is a schematic view illustrating an example of coils applied to the optical head apparatus described with reference to FIG. 4.

As shown in FIG. 5, a coil body 400 has a plurality of pattern coils being connected with each other by a predetermined method. For example, pattern coils 410, 420, 430, 440 and 450 formed on, e.g., each flat substrate having a predetermined thickness are arranged at predetermined positions.

The coils 410, 420, 430, 440 and 450 have convoluted shapes each having a predetermined direction, and convoluted conducting wires in opposite directions are alternately arranged. For example, the coils 410, 430 and 450 are formed in the counterclockwise direction from the outer periphery toward the inner periphery, and the coils 420 and 440 are formed in the clockwise direction from the outer periphery toward the inner periphery.

The coil 420 is connected with the coil 410 at the center, and connected with the coil 430 at one end. Moreover, the coil 440 is connected with the coil 430 at the center, and connected with the coil 450 at one end. One end of each of the coils 410 and 450 is used as an input/output terminal of the coil body 400.

The coil patterns 410, 420, 430, 440 and 450 overlap with a predetermined arrangement when matched with each other by using a central portion (through hole). When an external force is applied in the overlap state, the opposed surfaces are brought into contact with each other. The both surfaces to be in contact can be bonded by using a predetermined bonding method (e.g., by using an adhesive).

At this time, in order to avoid conduction in the conducting wire between the coils, a coil whose surface is insulated is utilized. It is to be noted that bonding can be effected by using an adhesive having insulating properties.

When predetermined currents, e.g., a plus current and a minus current are supplied to one end of the coil 410 and the coil 450, respectively, the coils 410, 420, 430, 440 and 450 are conducted in the mentioned order. As shown in FIG. 5, the currents flow through the contact parts in the same direction. With this structure, it is possible to suppress generation of a force which cancels out drive forces to be formed when the currents are supplied to the coils.

Additionally, as a lamination of the sheets having the coils with this structure, combinations of other examples can be also considered. For example, a laminated coil having the structure shown in FIG. 5 can be formed by preparing a sheet having the coils 410 and 420 and the coils 430 and 440 arranged on both surfaces thereof and folding it in such a manner that the adjacent coils 420 and 430 are opposed to each other.

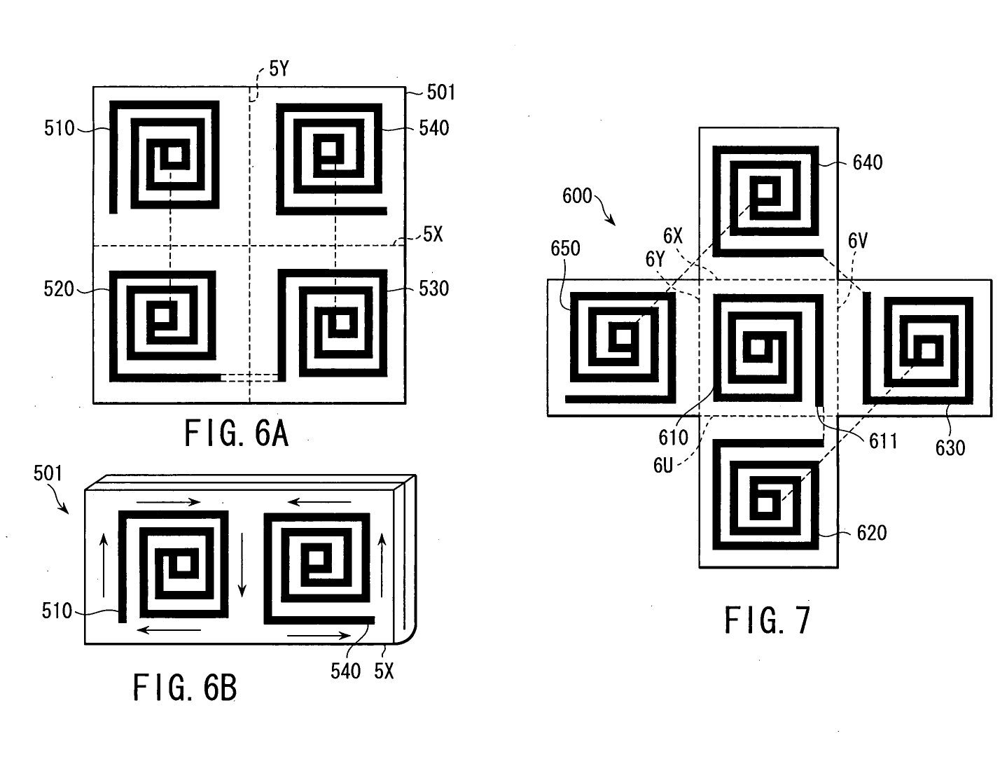

FIGS. 6A and 6B are schematic views illustrating another example of coils applied to the optical head apparatus described with reference to FIG. 4.

As shown in FIG. 6A, coils 510, 520, 530 and 540 which are printed at predetermined positions are formed on a flat sheet 501.

The coils 510, 520, 530 and 540 have convoluted shapes having the same direction. For example, they are formed in the clockwise direction from the outer periphery toward the inner periphery.

As shown in FIG. 6B, the sheet 501 is folded at a dotted line 5X, and the two coils which are adjacent to each other in the parallel direction, e.g., the coils 510 and 520 and the coils 530 and 540 are connected with each other at the central part, respectively. When a predetermined external force is applied in the folded state, the opposed faces of the sheet 501 are brought into contact with each other. It is to be noted that an adhesive or the like may be arranged between the surfaces to be brought into contact with each other. A coil body 501 is constituted of a two-layer coil surface, and can form coils which are respectively connected in series.

When a predetermined current is supplied to one end of each of the coils 510 and 540 as input/output terminals, the coils 510, 520, 530 and 540 are conducted in the mentioned order or the reversed order. As shown in FIG. 6B, the current flows through the parts to be in contact in the same direction.

Further, the sheet 501 is folded at a doted line 5Y in such a manner that the coils 520 and 530 are opposed to each other. Therefore, there is formed a coil body which is constituted of a four-layer coil surface and whose coils are respectively connected with each other in series. It is to be noted that the current flows through the contact parts of this coil body in the same direction.

FIG. 7 is a schematic view illustrating still another example of coils applied to the optical head apparatus described in conjunction with FIG. 4.

As shown in FIG. 7, print coils 610, 620, 630, 640 and 650 which are arranged in a cruciform are formed on a sheet 600. The coil 610 positioned at the center has a convoluted shape having a predetermined direction, and it is formed in, e.g., the counterclockwise direction from the outer periphery toward the inner periphery.

The coil 620 arranged below the coil 610 is folded at a dotted line 6U. When a predetermined external force is applied in the folded state, the coil 620 comes into contact with the coil 610. The coil 620 has a convoluted shape in the same direction as that of the coil 610 which is in contact therewith, and it is formed in, e.g., the counterclockwise direction from the outer periphery toward the inner periphery.

Further, on the coil 620, the coils 630, 640 and 650 are respectively folded on the coil 610 at dotted lines 6V, 6X and 6Y in sequence, and they respectively come into contact with each other on their surfaces. The coils 620 and 630 and the coils 640 and 650 are connected with each other at the center, and the coil 630 is connected with the coil 640 at one end.

The coils which are in contact with each other in the lamination direction respectively have convoluted shapes in opposite directions.

A predetermined current is supplied to one end of each of the coils 650 and 620 which are input/output terminals. When the coils 620, 630, 640 and 650 are conducted in the mentioned order or the reversed order, the current flows through their contact parts in the same direction. Furthermore, when the coil 620 is connected with the coil 610 at one end, the current is supplied from a central portion of the coil 610 and one end portion of the coil 650, and the coils 610, 620, 630, 640 and 650 are conducted in the mentioned order or the reversed order. As a result, the current flows through their contact parts in the same direction.

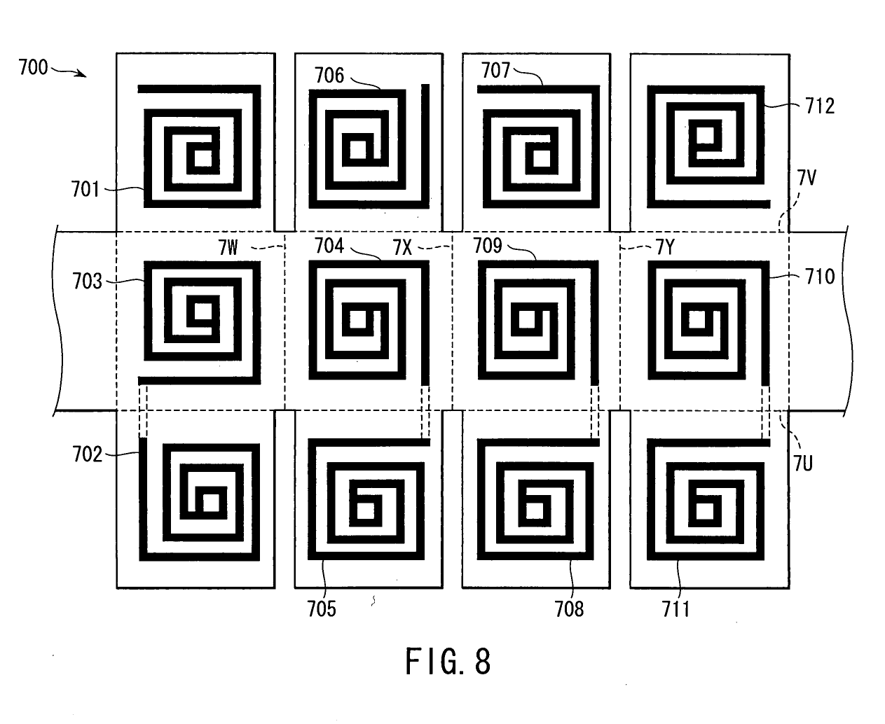

FIG. 8 is a schematic view illustrating another example of coils applied to the optical head apparatus described with reference to FIG. 4.

As shown in FIG. 8, coils 701 to 712 printed at predetermined positions are formed on a sheet 700 in three lines along a lateral direction in a page space. Coils (701, 706, 707, 712) in the upper line and coils (702, 705, 708, 711) in the lower line are separated from each other, and they are formed so as to be connected with the sheet on which coils (703, 704, 709, 710) in the middle (second) line are arranged.

Adjacent coils arranged at the center (second line) are alternately connected with each other at the center. That is, the coils 703 and 704 and the coils 709 and 710 are connected with each other. The coils 703, 704, 709 and 710 have convoluted shapes in the same direction, and they are formed in, e.g., the counterclockwise direction from the outer periphery toward the inner periphery.

The coil 702 connected at one end with the upper side of the coil 703 arranged at the center is folded at a dotted line 7U. When a predetermined external force is applied in the folded state, the coils 703 and 702 come into contact with each other. Thereafter, the coil 701 folded at a dotted line 7V comes into contact with the upper side of the coil 702. It is to be noted that the coils 701 and 702 are connected with each other at the center.

Likewise, the other coils 704, 709 and 710 arranged at the center respectively come into contact with the coils 705, 708 and 711 which are brought into contact therewith at one end. Additionally, the coils 705, 708 and 711 respectively come into contact with the coils 706, 707 and 712 which are connected at the center.

The coil 703 with which the coils 701 and 702 come into contact is connected with and comes into contact with the coil 704 when the coil 704 is folded at a dotted line 7W. Further, the coil 709 comes into contact with the coil 710 which is connected at the center.

Thus, there are formed a coil body which includes the coils 701 to 706 and has input/output terminals provided at the coils 701 and 706, and a coil body which includes the coils 707 to 7012 and has input/output terminals provided at the coils 707 and 7012.

Furthermore, when folded at a dotted line 7X, the coil 706 comes into contact with the coil 707 which is connected at one end. Therefore, there is formed a coil body which includes the coils 701 to 712 and has input/output terminals at the coils 701 and 712.

When a predetermined current is supplied to one end of each of the input/output terminals 701 and 712, the coils 701 to 712 are conducted in the mentioned order. With this structure, the current flows through their contact parts in the same direction. Moreover, many coils can be laminated at the same time.

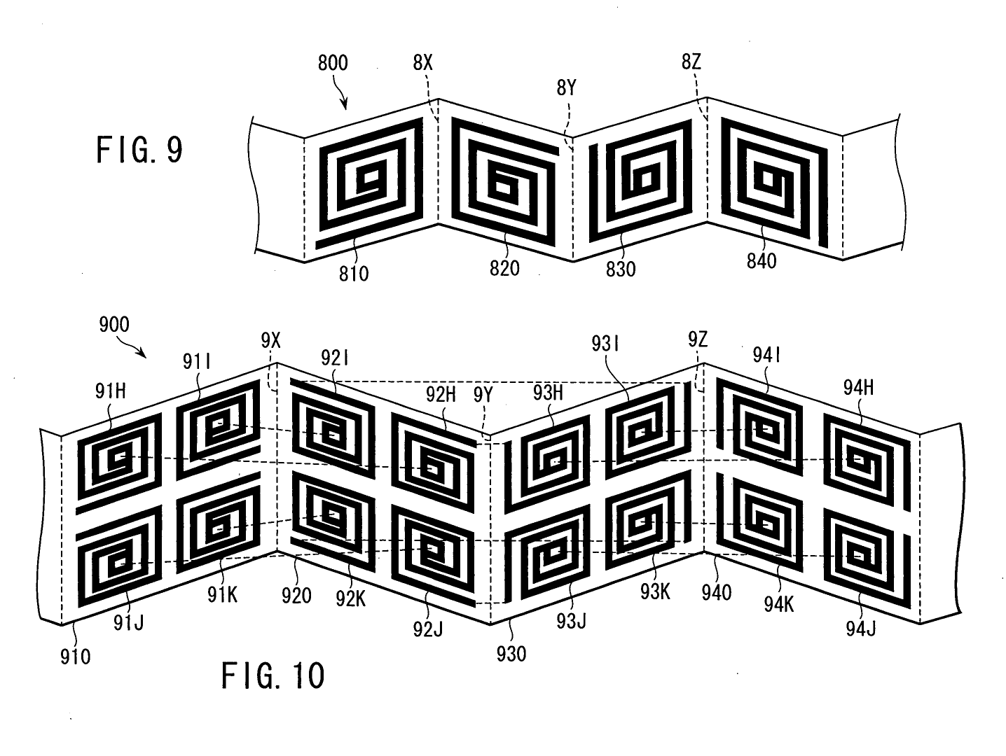

FIG. 9 is a schematic view illustrating still another example of coils applied to the optical head apparatus described in conjunction with FIG. 4.

As shown in FIG. 9, print coils 810, 820, 830 and 840 which are arranged in a line are formed on a zonal sheet 800. The coils 810, 820, 830 and 840 have the convoluted shapes having the same direction, and they are formed in, e.g., the counterclockwise direction from the outer periphery toward the inner periphery.

The coil 810 comes into contact with the coil 820 which is connected therewith at the center when folded at a dotted line 8X. Additionally, the coil 830 comes into contact with the coil 840 which is connected therewith at the center when folded at a dotted line 8Z. The coil 820 comes into contact with the coil 830 which is connected therewith at one end when folded at a dotted line 8Y.

With this structure, an arbitrary number of coil surfaces can be laminated. It is to be noted that a current flows through contact parts of a coil body in the same direction.

FIG. 10 is a schematic view illustrating yet another example of coils applied to the optical head apparatus described with reference to FIG. 4.

As shown in FIG. 10, coil bodies 910, 920, 930 and 940 having predetermined patterns are continuously arranged on a sheet 900.

The coil bodies 910 to 940 have diagonal coils having convoluted shapes in the same direction, and adjacent coils have convoluted shapes in the opposite directions. For example, to the coil body 910 are formed coils 911 and 91J formed in the clockwise direction from the outer periphery toward the inner periphery and coils 91H and 91K having convoluted shapes in the opposite directions.

Further, to the coil body 920 are arranged coils as a mirror image of the adjacent coil body 910. Therefore, for example, the coils 92H and 92K are formed in the counterclockwise direction from the outer periphery toward the inner periphery, and the coils 921 and 92J are formed into the convoluted shapes in the opposite directions.

Furthermore, to the coil bodies 930 and 940 are arranged coils as mirror images of the coil bodies 910 and 920. Therefore, as will be described later, the coils having the convoluted shapes in the opposite directions are arranged so as to come into contact with each other in the folded state.

The coil body 920 is connected at the center in such a manner that its alphabets H, I, J and K match with the coils 91H, 91I, 91J and 91K arranged on the coil body 910.

The coil body 920 is folded at a dotted line 9X. When a predetermined external force is applied in the folded state, the coil 920 comes into contact with the coil body 910.

Likewise, the coil body 930 is folded at a dotted line 9Z and comes into contact with the coil body 940. The coils whose alphabets H, I, J and K match with the counterparts are connected with each other at the center.

The coils 92H, 92I, 92J and 92K of the coil body 920 can be connected with the coils 93H, 93I, 93J and 93K of the coil body 930 at their ends on one side. The coil body 920 is folded at a dotted line 9Y and comes into contact.

With this structure, as described above, when the coils arranged on the coil bodies 920 and 930 are brought into contact, a coil body having input/output terminals at the coils 910 and 940 is formed. The coil body in which four sheet layers are laminated can constitute four four-layer coils (or eight two-layer coils).

When a predetermined current is supplied to the input/output terminals, the coil bodies 910 to 940 are conducted in the mentioned order or the reversed order. It is to be noted that the current flows through the contact parts in the same direction.

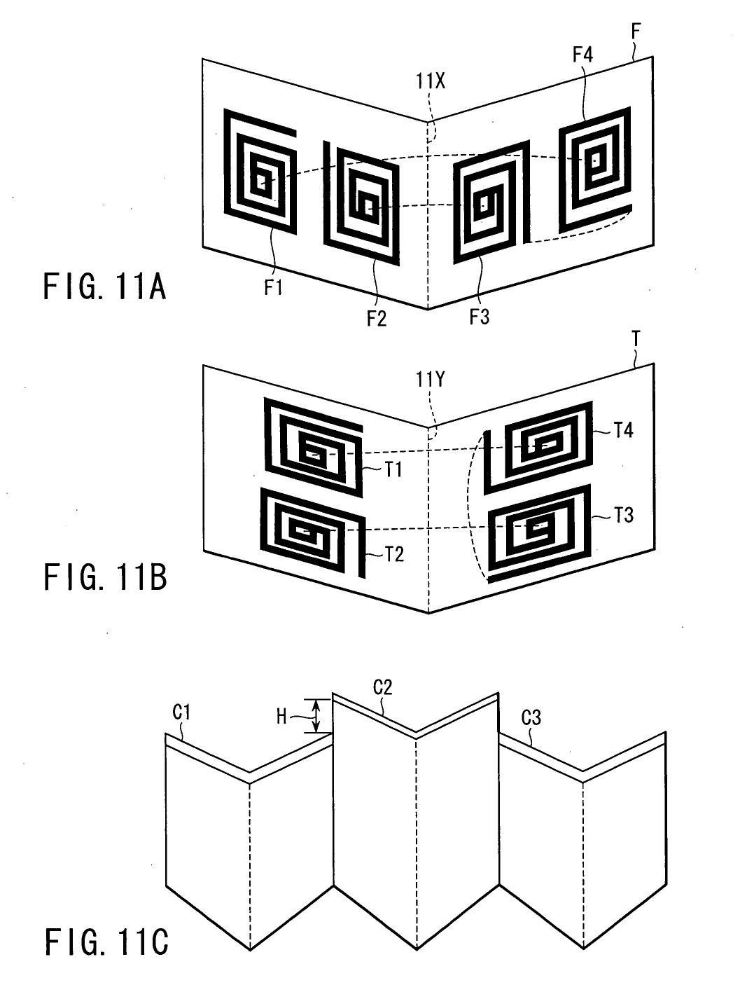

FIGS. 11A, 11B and 11C are schematic views illustrating a further example of coils applied to the optical head apparatus described in conjunction with FIG. 4.

As shown in FIGS. 11A and 11B, to sheets F and T are formed a plurality of coils arranged at predetermined positions in such a manner that currents flow in predetermined directions.

As shown in FIG. 11A, print coils F1, F2, F3 and F4 are arranged at predetermined positions on the sheet F so as to form a flow of a current in the lateral direction in the page space. The coils F1, F2, F3 and F4 have the convoluted shapes having the same direction. For example, they are formed in the counterclockwise direction from the outer periphery toward the inner periphery. F3 is connected with F4 at one end.

The coil F is folded at a dotted line 11X. When an external force is applied in the folded state, the coils F1 and F4 and the coils F2 and F3 come into contact with each other. Therefore, the coils F1 and F4 and the coils F2 and F3 are connected with each other at the center.

When a predetermined current is supplied to one end of each of the coils F1 and F2 as input/output terminals, the coils F1, F4, F3 and F2 are conducted in the mentioned order or the reversed order. It is to be noted that a current flows through their contact parts in the same direction.

As shown in FIG. 11B, print coils T1, T2, T3 and T4 are arranged at predetermined positions on the sheet T so as to form a flow of a current in the vertical direction in the page space. The coils T1, T2, T3 and T4 have convoluted shapes having the same direction. For example, they are formed in the counterclockwise direction from the outer periphery toward the inner periphery. T3 is connected with T4 at one end.

The coil F is folded at a dotted line 11Y, and the coils T1 and T4 and the coils T2 and T3 are brought into contact with each other. Therefore, the coils T1 and T4 and the coils T2 and T3 are respectively connected with each other at the center.

When a predetermined current is supplied to one end of each of the coils T1 and T2 as input/output terminals, the coils T1, T4, T3 and T2 are conducted in the mentioned order or the reversed order. It is to be noted that the current flows through their contact parts in the same direction.

FIG. 11C is a schematic view illustrating a combination of the sheets F and T.

As shown in FIG. 11C, foldable sheets C1, C2 and C3 are arranged at predetermined positions. As the sheets C1, C2 and C3, it is possible to utilize sheets having such coil patterns as shown in FIGS. 11A and 11B. The sheets C1, C2 and C3 are superposed with a predetermined arrangement. It is to be noted that the sheets C1, C2 and C3 can be integrally formed. Therefore, as shown in FIG. 11C, there is formed a coil body in which a plurality of flat coils are laminated when folded.

For example, the sheet F is applied as C1 and C3, and the sheet T is applied as C2. Moreover, a coil in which a plurality of sheets F are laminated can be applied as the sheet C1.

It is to be noted that C2 shown in FIG. 11C is largely formed as compared with the other sheets in such a manner that an upper portion thereof has a width H. Therefore, the input/output terminals of C1 to C3 can be readily formed. It is to be noted that C2 may have the same size as those of the other sheets.

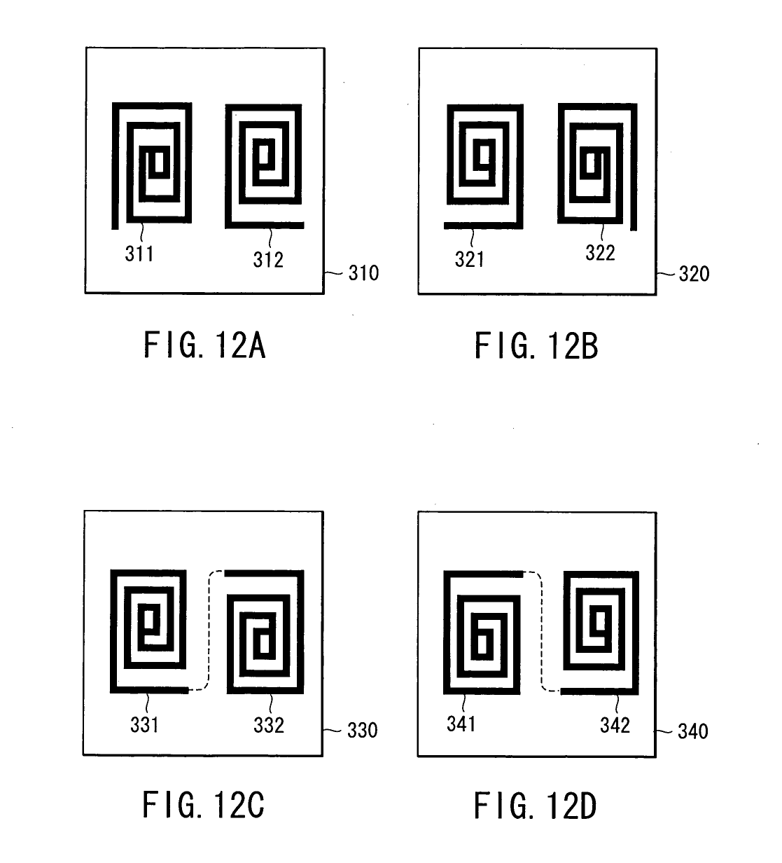

FIGS. 12A to 20 are schematic views illustrating other examples of coils applied to the optical head apparatus described in conjunction with FIG. 4.

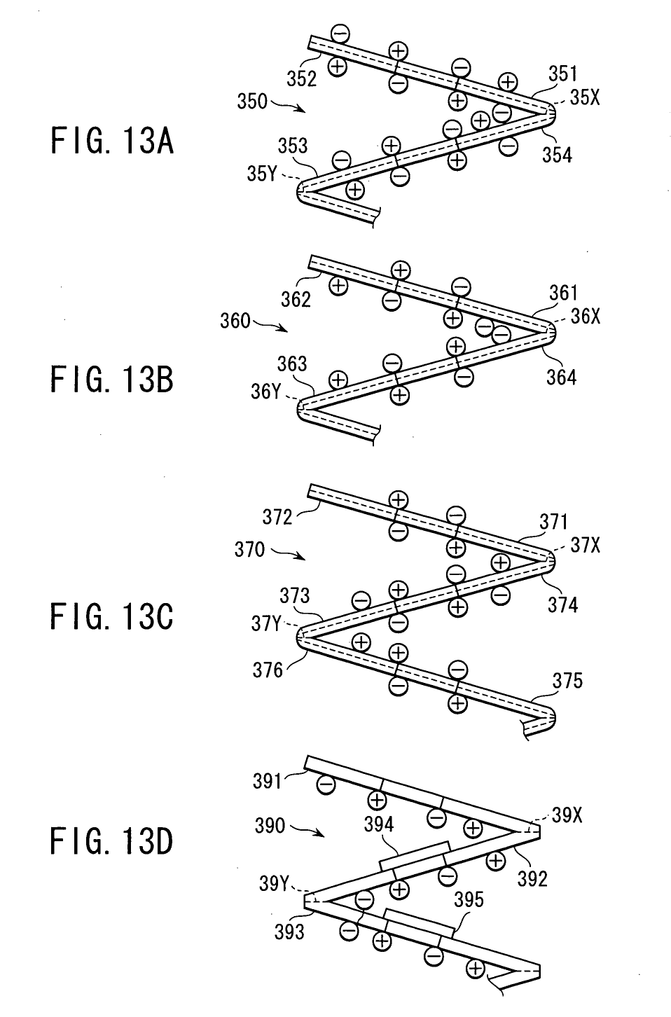

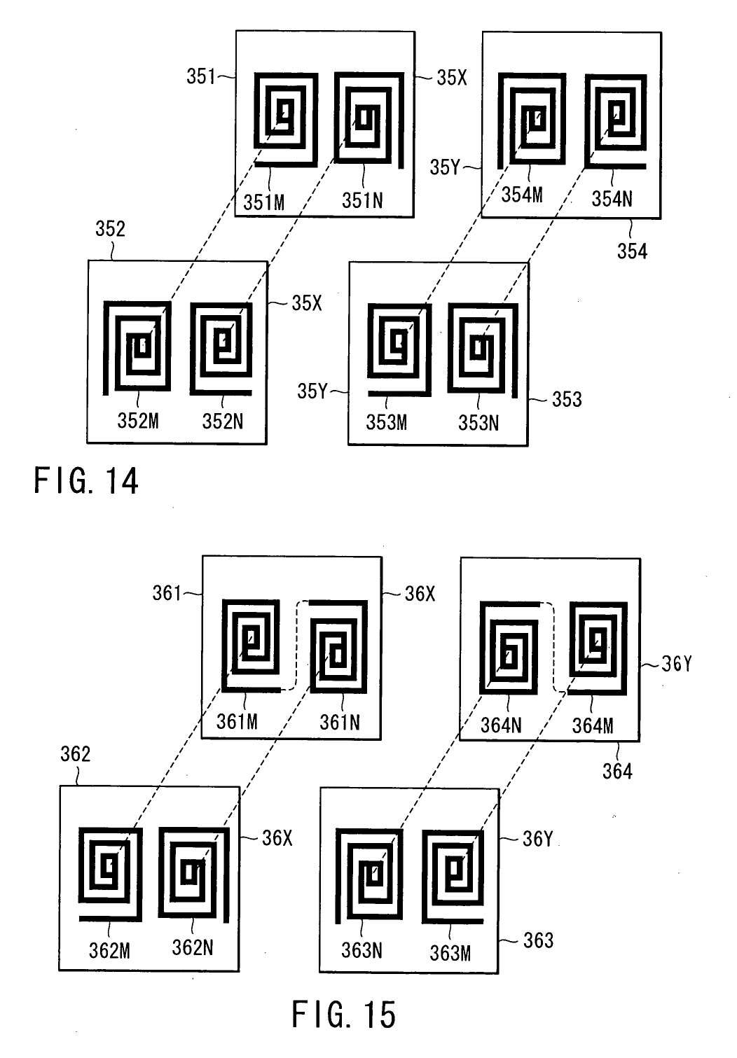

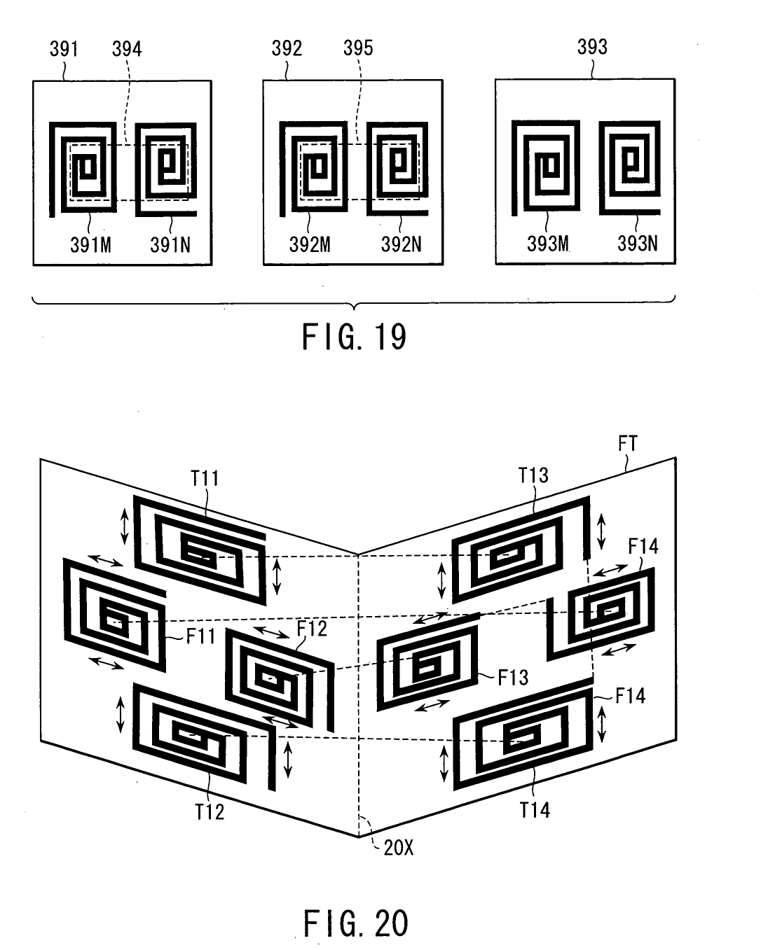

FIGS. 12A to 12D are plane views showing patterns of flat coils applied to this embodiment. FIGS. 13A to 13D are schematic views illustrating an example of a combination of sheets on which the patterns shown in FIGS. 12A to 12D are formed. FIGS. 14 to 19 are schematic views illustrating contacts of the coils depicted in FIGS. 13A to 13D. Additionally, FIGS. 14 to 18 perspectively show arrangements of the coils seen from the left side in the page spaces of FIGS. 13A to 13C. It is to be noted that FIG. 19 perspectively shows an arrangement of the coils seen from the lower side in the page space of FIG. 13D. As shown in FIGS. 12A and 12B, sheets 310 and 320 have coils with convoluted shapes having the same direction in accordance with each sheet.

On the sheet 310 are formed convoluted coils 311 and 312 in the clockwise direction from the outer periphery toward the inner periphery. On the sheet 320 are formed convoluted coils 321 and 322 in the counterclockwise direction from the outer periphery toward the inner periphery. It is to be noted that the coils 321 and 322 can be arranged at positions where they can come into contact with the coils 311 and 312 at the center or one end as will be described later when the sheets 310 and 320 are brought into contact with each other.

As shown in FIGS. 12C and 12D, each of sheets 330 and 340 has convoluted coils having the same direction.

On the sheet 330 are formed convoluted coils 331 and 332 in the clockwise direction from the outer periphery toward the inner periphery at predetermined positions. Further, on the sheet 340 are formed convoluted coils 341 and 342 in the counterclockwise direction from the outer periphery toward the inner periphery. The coils 331 and 332 and the coils 341 and 342 are respectively connected with each other at one end.

Incidentally, like the coils 310 and 320, the coils 341 and 342 can be arranged at positions where they can come into contact with the coils 331 and 332 at the center as will be described later when the sheets 330 and 340 are brought into contact with each other. With this arrangement, when the sheets 310 to 340 or the like are superposed, arbitrary coils can be matched by using a central portion (through hole), and hence they can come into contact with each other with predetermined arrangements.

It is to be noted that coils patterns shown in FIGS. 12A to 12D are referred to as patterns A, B, C and D for the convenience's sake.

As FIGS. 14 to 19 show, the coils, each indicated by a reference symbol including M or N, are provided on each coil surface of the coil bodies 350 to 390. And, the coil bodies 350 to 390 are fold such that any coil bodies identified by reference symbols including the same letter overlap one another.

FIGS. 13A to 13D depict the coil bodies as viewed from the upper sides of the coil surfaces show in FIGS. 14 to 19, respectively. The coils identified by reference symbols including M are located on the left, whereas the coils identified by reference symbols including N are located on the right.

For simplicity of description, any pattern as viewed from the reverse side of the sheet will be called “see-through pattern”. It is to be noted that FIGS. 12A to 12D description the right side of the sheets 310 to 340.

Needless to say, the see-through pattern is a mirror image to the pattern printed on the obverse side of the sheet.

A description will now be given as to an example of coils having the patterns shown in FIGS. 12A and 12B with reference to FIGS. 13A and 14.

As shown in FIGS. 13A and 14, a coil body 350 is a coil in which a sheet having surfaces 351 and 352 and a sheet having surfaces 353 and 354 are laminated.

It is to be noted that the surfaces 352 and 353 are arranged so as to be opposed to each other as shown in FIG. 13A.

As shown in FIG. 14, the surface 351 is the see-through pattern as viewed from the surface 352, and the surface 353 is the see-through pattern as viewed from the surface 354. And the surfaces 352 and 354 illustrate the pattern printed. It is to be noted that the surfaces 351 to 354 printed the pattern B. Coils 352M and 352N arranged on the surface 352 are respectively connected with coils 351M and 351N on the surface 351 at the center.

Further, coils 354M and 354N arranged on the surface 354 are respectively connected with coils 353M and 353N arranged on the surface 353 at the center.

The sheet 350 can be folded at a dotted line 35X in such a manner that the surfaces 352 and 353 whose both surfaces are insulated are opposed to each other. Furthermore, it may be bonded by a predetermined method.

Therefore, there is formed the coil body including the coils 351M and 352M, the coils 351N and 352N, the coils 353M and 354M and the coils 353N and 354N.

Moreover, as a lamination of the sheet having the coils based on this structure, there can be considered a coil body having wirings of another example. For example, it is a coil body in which one end of each of the coils 351M and 351N is connected with one end of each of the coils 354M and 354N. A first current (e.g., a plus current) is supplied to one end of each of the coils 352M and 353N, and a second current (e.g., a minus current) is supplied to one end of each of the coils 352N and 353M. With this structure, the currents in the same direction flow through the contact surfaces.

A description will now be given as to an example of coils having the patterns depicted in FIGS. 12A to 12D with reference to FIGS. 13B and 15.

As shown in FIG. 13B, a coil body 360 is a coil in which a sheet having surfaces 361 and 362 and a sheet having surfaces 363 and 364 are laminated.

It is to be noted that the surfaces 362 and 363 are arranged so as to be opposed to each other as shown in FIG. 13B.

As shown in FIG. 15, the surface 361 is the see-through pattern as viewed from the surface 362, and the surface 364 is the see-through pattern as viewed from the surface 363. And the surfaces 362 and 363 illustrate the pattern printed.

The pattern D is formed on the surface 361, the pattern B is formed on the surface 362, the pattern A is formed on the surface 363, and the pattern C is formed on the surface 364. Coils 361M and 361N arranged on the surface 361 are respectively connected with coils 362M and 362N arranged on the surface 362 at the center.

The sheet 360 can be folded at a dotted line 36X in such a manner that the surfaces 362 and 363 whose both surfaces are insulated are opposed to each other. Additionally, it may be bonded by a predetermined method.

When predetermined currents, e.g., a plus current is supplied to one end of each of the coils 362M and 363M and a minus current is supplied to one end of each of the coils 362N and 363N, the coils 362M, 361M, 361N and 362N are conducted in the mentioned order. At the same time, the coils 363M, 364M, 364N and 363N are conducted in the mentioned order.

It is to be noted that the currents flow through the contact parts in the same direction in the laminated state. With this structure, it is possible to suppress a force which cancels out drive forces to be formed when the currents are supplied to the coils.

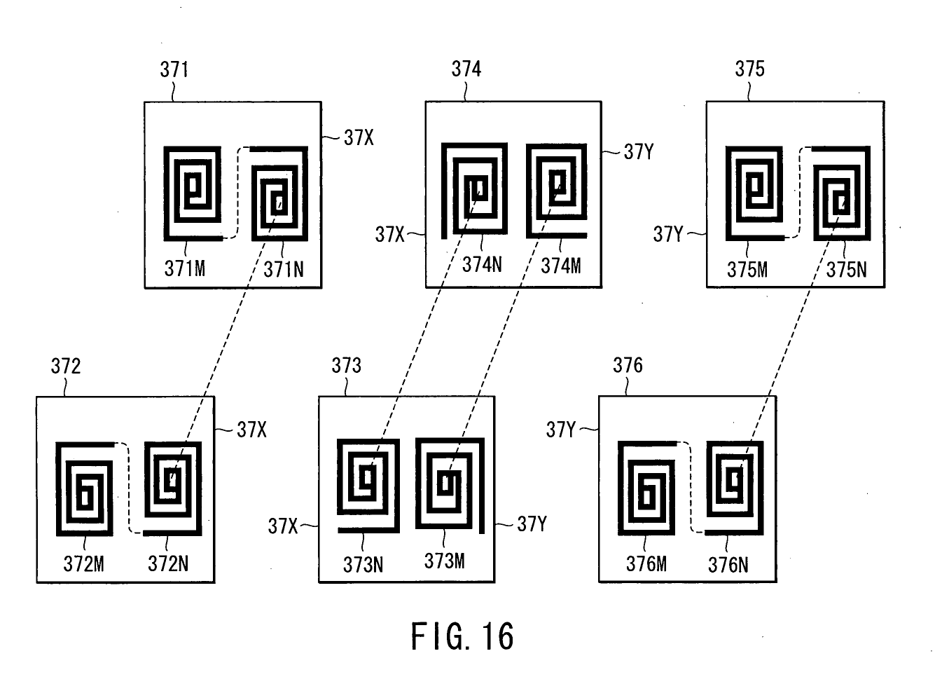

A description will now be given as to a yet further example of coils having the patterns shown in FIGS. 12A to 12D with reference to FIGS. 13 and 16.

As shown in FIG. 13C, a coil body 370 is a coil in which a sheet having surfaces 371 and 372, a sheet having surfaces 373 and 374 and a sheet having surfaces 375 and 376 are laminated.

It is to be noted that the surfaces 372 and 373 and the surface 374 and 375 are arranged so as to be opposed to each other as shown in FIG. 13C.

As shown in FIG. 16, the surfaces 371 is the see-through pattern as viewed from the surface 372, the surface 374 is the see-through pattern as viewed from the surface 373, and the surface 375 is the see-through pattern as viewed from the surface 376. And the surfaces 372, 373 and 376 illustrate the pattern printed.

The pattern D is formed on the surfaces 371 and 372. A coil 371N arranged on the surface 371 is connected with a coil 372N arranged on the surface 372 at the center.

The pattern B is formed on the surface 373, and the pattern B is formed on the surface 374. Coils 374M and 374N arranged on the surface 374 are respectively connected with coils 373M and 373N arranged on the surface 373 at the center.

Further, the pattern D is formed on the surfaces 375 and 376. A coil 375N arranged on the surface 375 is connected with a coil 376N arranged on the surface 376 at the center.

The sheet 370 can be folded at a dotted line 37X in such a manner that the surface 372 and 373 whose both surfaces are insulated are opposed to each other. Furthermore, it may be bonded by a predetermined method.

When predetermined currents, e.g., a plus current is supplied to the center of each of the coils 371M and 375M and one end of each of the coils 373N and 374M and a minus current is supplied to the center of each of the coils 372M and 376 and one end of each of the coils 373M and 374N, the respective connected coils are conducted. It is to be noted that the currents flow through the contact parts in the same direction in the laminated state.

Moreover, as a lamination of the sheets having the coils based on this structure, there can be considered a coil body having wirings of another example. One example will now be described hereunder.

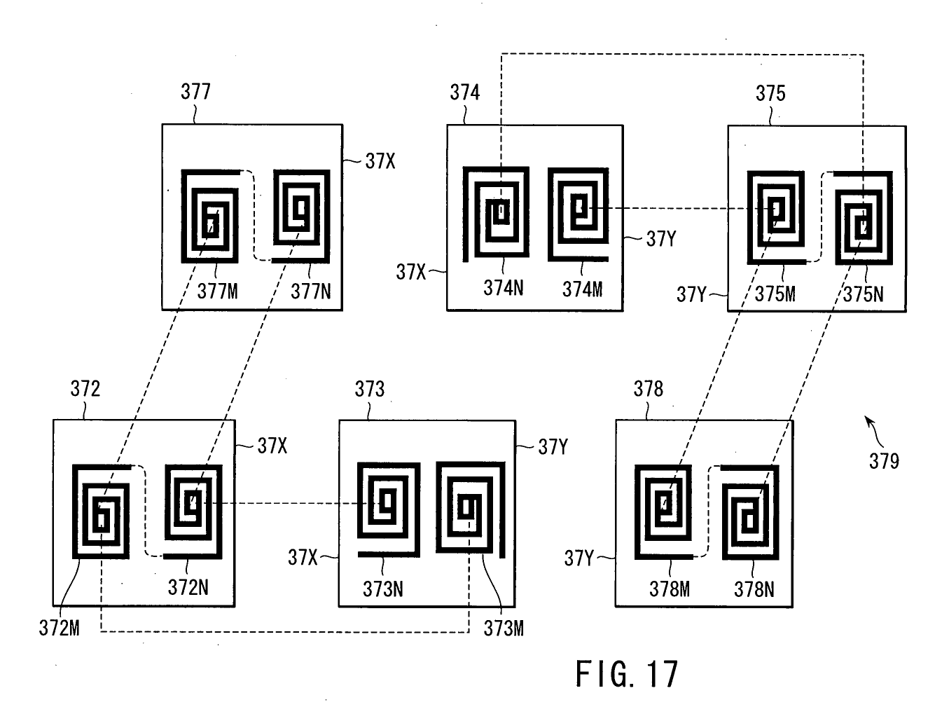

A description will now be given as to a yet further example of coils having the patterns shown in FIGS. 12A to 12D with reference to FIG. 17.

As shown in FIG. 17, a coil body 379 is a coil in which a sheet having surfaces 377 and 372, a sheet having surfaces 373 and 374 and a sheet having surfaces 375 and 378 are laminated.

It is to be noted that the surfaces 372 and 373 and the surface 374 and 375 are arranged so as to be opposed to each other.

As shown in FIG. 17, the surface 377 is the see-through pattern as viewed from the surface 372, the surface 374 is the see-through pattern as viewed from the surface 373, and the surface 375 is the see-through pattern as viewed from the surface 376. And the surfaces 352 and 354 illustrate the pattern printed.

As shown in FIG. 17, the pattern C is formed on the surface 377, the pattern D is formed on the surface 372, and the pattern B is formed on the surface 373. A coil 371M arranged on the surface 371 is connected with a coil 372M arranged on the surface 372 at the center. And A coil 371N arranged on the surface 371 is connected with a coil 372N arranged on the surface 372 at the center. Further the coil 372M arranged on the surface 372 is connected with a coil 373M arranged on the surface 373 at the center. And the coil 372N arranged on the surface 372 is connected with a coil 373N arranged on the surface 373 at the center.

The pattern B is formed on the surface 374, the pattern D is formed on the surface 375, and the pattern C is formed on the surface 378. Coils 378M and 378N arranged on the surface 378 are respectively connected with coils 375M and 375N arranged on the surface 375 at the center. And the coils 375M and 375N arranged on the surface 375 are respectively connected with the coils 374M and 374N arranged on the surface 374 at the center.

The sheet 378 can be folded at a dotted line 37X in such a manner that the surface 372 and 373 whose both surfaces are insulated are opposed to each other. Furthermore, it may be bonded by a predetermined method.

When predetermined currents, e.g., a plus current is supplied to the one end of each of the coils 373N and 374M and a minus current is supplied to the one end of each of the coils 373M and 374N, the respective connected coils are conducted. It is to be noted that the currents flow through the contact parts in the same direction in the laminated state.

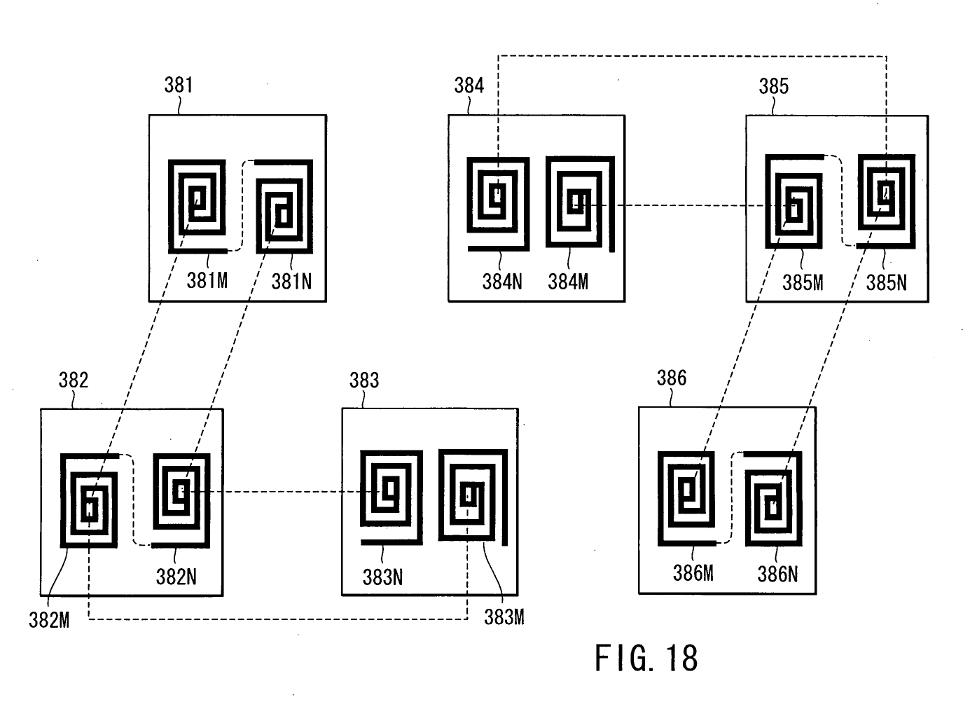

A description will now be given as to another example of coils having any of the patterns shown in FIGS. 12A to 12D with reference to FIG. 18.

A coil body 380 in which a sheet having surfaces 381 and 382, a sheet having surfaces 383 and 384 and a sheet having surfaces 385 and 386 are laminated.

As shown in FIG. 18, the surfaces 381 is the see-through pattern as viewed from the surface 382, the surface 384 is the see-through pattern as viewed from the surface 383, and the surface 385 is the see-through pattern as viewed from the surface 386. And the surfaces 382, 383 and 386 illustrate the pattern printed.

It is to be noted that bonding of the sheets are referred by replacing a digit of the + sign since this coil body is similar to the coil body 370 depicted in FIG. 13C. In the coil body 380, therefore, the surfaces 382 and 383 and the surfaces 384 and 385 can be bonded by a predetermined method.

The pattern C is formed on the surface 381, the pattern D is formed on the surface 382, and the pattern B is formed on the surface 383. Coils 381M and 381N arranged on the surface 381 are respectively connected with coils 382M and 382N arranged on the surface 382 at the center. The coils 382M and 382N are respectively connected with coils 383M and 383N arranged on the surface 383 at the center.

Furthermore, the pattern A is formed on the surface 374, the pattern C is formed on the surface 385, and the pattern D is formed on the surface 386. Coils 386M and 386N arranged on the surface 386 are respectively connected with coils 385M and 385N arranged on the surface 385 at the center. The coils 385M and 385N are respectively connected with coils 384M and 384N arranged on the surface 384 at the center.

The coils 384M and 384N are respectively connected with the coils 383M and 383N at one end.

When predetermined currents, e.g., a plus current is supplied to one end of each of the coils 383M and 384M and a minus current is supplied to the coils 383N and 384N, the respective connected coils are conducted. It is to be noted that the currents flow through the contact parts in the same direction in the laminated state.

A description will now be given as to an example of coils having the pattern shown in FIG. 12A or FIG. 12B with reference to FIGS. 13D and 19.

As shown in FIG. 13D, a coil body 390 is a coil in which a sheet having a surface 391, a sheet on which a conducting pad 934 is arranged at a position on a surface opposed to the surface 391 and which has another surface 392, and a sheet on which a conducting pad is arranged at a position on a surface opposed to the surface 392 and which has another surface 393 are laminated.

As shown in FIG. 19, the pattern A is formed on the surfaces 391 to 393. It is to be noted that the pattern B may be formed on these surfaces.

Coils 391M and 391N arranged on the surface 391 can be conducted by using the conducting pad 394 which is in contact with the central portions of the both coils. Further, coils 392M and 392N arranged on the surface 392 can be conducted by utilizing the conducting pad 395 which is in contact with the central portions of the both coils.

The sheet 390 is folded at dotted lines 39X in such a manner that the rear surface of the surface 392 and the surface 391 are opposed to each other. And the sheet 390 is folded at dotted lines 39Y in such a manner that the rear surface of the surface 392 and the surface 393 are opposed to each other. It is to be noted that a conductive thin pad is used as the conducting pad and it may have the adhesiveness. Therefore, the opposed surfaces are brought into contact with each other in the folded state.

FIG. 20 is a schematic view illustrating another example of coils applied to the optical head apparatus described in conjunction with FIG. 4.

As shown in FIG. 20, to a coil body FT are formed a plurality of coils which are arranged at predetermined positions in such a manner that currents flow in predetermined directions.

Print coils F11 and F12 are arranged at predetermined positions on the sheet FT so as to be capable of forming a flow of a current in the lateral direction in each of four divided sheets FT so that a flow of a current in the lateral direction in one page space is formed as shown in FIG. 20. The coils F11 and F12 have convoluted shapes having the same direction. For example, they are formed in the counterclockwise direction from the outer periphery toward the inner periphery.

F13 and F14 are arranged at positions where they come into contact with F12 and F11 at the center when folded at a dotted line 20X. Furthermore, F13 and F14 are formed into convoluted shapes in the same direction as that of F11 and F12.

Moreover, on the sheet FT, print coils T11 and T12 are arranged above and below the coils F11 and F12 in such a manner that a flow of a current in the vertical direction is formed in the page space as shown in FIG. 20.

The coils T11 and T12 have the convoluted shapes having the same direction. For example, they are formed in the counterclockwise direction from the outer periphery toward the inner periphery. T13 and T14 are arranged at positions where they come into contact with T12 and T11 at the center when folded at a dotted line 20X. Additionally, T13 and T14 are formed into the convoluted shapes in the same direction as that of the coils T11 and T12.

The coils T11 and T13 and the coils T12 and T14 are bonded so as to be capable of being connected at the center when the coil FT is folded at the dotted line 20X. Further, the coils F11 and F13 and the coils F12 and F14 are bonded so as to be capable of being connected at the center.

When predetermined currents, e.g., a plus current is supplied to one end of each of the coils F11 and T11 and a minus current is supplied to the coils F12 and T12, the respective connected coils are conducted. It is to be noted that the currents flow through the contact parts in the same direction in the laminated state.

As described above, according to the present invention, it is possible to form coils which are small in size and thickness, have a light weight and the large number of windings, thereby improving the sensitivity of the actuator. As a result, there can be obtained the optical head apparatus which can operate at a high double speed and has a low power consumption.

Furthermore, according to the present invention, when predetermined currents are supplied in the laminated state, the currents flow through predetermined contact parts in the same direction.

What is claimed is:

1. An optical head apparatus comprising:
an object lens which condenses light beams onto a recording surface of an information recording medium or the like which records information;
a lens holder which holds the object lens so as to be movable in an optical axis direction of the object lens and a direction parallel with the recording surface of the information recording medium;
a magnet which can provide a magnetic field having a predetermined polarity;
a flat coil which has a conductor composed of a metal foil or a metal pattern and formed into a coil shape on a sheet medium at a predetermined position of the lens holder and which generates a force in accordance with the magnetic field in order to move the lens holder at least in one of the optical axis direction and the direction parallel with the recording surface; and
a support member which supports the lens holder so as to be movable in predetermined directions.

2. The optical head apparatus according to claim 1, wherein the flat coil is formed by laminating a plurality of sheet mediums having the metal foil or the metal pattern formed thereon.

3. The optical head apparatus according to claim 2, wherein the flat coil includes a coil having a first pattern which generates a thrust in a first direction in order to move the lens holder at least in the optical axis direction, and a coil having a second pattern which generates a thrust in a second direction orthogonal to the first direction in order to move the lens holder at least in the direction parallel with the recording surface.

4. The optical head apparatus according to claim 2, wherein the two or more flat coils are provided with a magnetic body sandwiched therebetween.

5. The optical head apparatus according to claim 2, wherein the flat coil includes a coil having a third pattern which generates a third thrust in order to move the lens holder in the first direction in accordance with a displacement of the first direction based on a rotation cycle of the recording medium.

6. The optical head apparatus according to claim 1, wherein the flat coil is formed by folding and laminating a plurality of sheet mediums having a predetermined shape to which the metal foil or the metal pattern is formed.

7. The optical head apparatus according to claim 6, wherein the flat coil includes a coil having a first pattern which generates a thrust in a first direction in order to move the lens holder at least in the optical axis direction, and a coil having a second pattern which generates a thrust in a second direction orthogonal to the first direction in order to move the lens holder at least in the direction parallel with the recording surface.

8. The optical head apparatus according to claim 6, wherein the two or more flat coils are provided with a magnetic body sandwiched therebetween.

9. The optical head apparatus according to claim 6, wherein the flat coil includes a coil having a third pattern which generates a third thrust in order to move the lens holder in the first direction in accordance with a displacement of the first direction based on a rotation cycle of the recording medium.

10. An optical head apparatus comprising:
an optical head which has: an object lens which condenses light beams onto a recording surface of an information recording medium or the like which records information; a lens holder which holds the object lens so as to be movable in an optical axis direction of the object lens and a direction parallel with the recording surface of the information recording medium; a magnet which can provide a magnetic field having a predetermined polarity; a flat coil which has a conductor composed of a metal foil or a metal pattern and formed into a coil shape on a sheet medium at a predetermined position of the lens holder and which generates a force in accordance with the magnetic field in order to move the lens holder at least in one of the optical axis direction and the direction parallel with the recording surface; and a support member which supports the lens holder so as to be movable in predetermined directions;
a photodetector which detects light beams reflected on the recording surface of the recording medium and converts them into an electric signal; and
an information processing circuit which reproduces information recorded in the recording medium from the electric signal outputted from the photodetector.

11. The optical head apparatus according to claim 10, wherein the flat coil is formed by laminating a plurality of sheet mediums to which the metal foil or the metal pattern is formed.

12. The optical head apparatus according to claim 11, wherein the flat coil includes a coil having a first pattern which generates a thrust in a first direction in order to move the lens holder at least in the optical axis direction, and a coil having a second pattern which generates a thrust in a second direction orthogonal to the first direction in order to move the lens holder at least in the direction parallel with the recording surface.

13. The optical head apparatus according to claim 11, wherein the two or more flat coils are provided with a magnetic body sandwiched therebetween.

14. The optical head apparatus according to claim 10, wherein the flat coil is formed by folding and laminating a plurality of sheet mediums having a predetermined shape to which the metal foil or the metal pattern is formed.

15. The optical head apparatus according to claim 14, wherein the flat coil includes a coil having a first pattern which generates a thrust in a first direction in order to move the lens holder at least in the optical direction and a coil having a second pattern which generates a thrust in a second direction orthogonal to the first direction in order to move the lens holder at least in the direction parallel with the recording surface.

16. The optical head apparatus according to claim 14, wherein the two or more flat coils are provided with a magnetic body sandwiched therebetween.
